(19) United States
(12) Patent Application Publication
(10) Pub. No.: US 2024/0042417 A1
(43) Pub. Date: Feb. 8, 2024

(54) THERMAL TREATMENT METHODS FOR POROUS PARTICLES

(71) Applicant: Phenomenex, Inc., Torrance, CA (US)

(72) Inventors: Michael Chitty, Torrance, CA (US); Arthur Roy Dixon, Crestline, CA (US); James Song, Buena Park, CA (US); Zhengfei Sun, Buena Park, CA (US); Zijie Wang, Tustin, CA (US); Yinfeng Zong, Moorpark, CA (US)

(21) Appl. No.: 18/360,529

(22) Filed: Jul. 27, 2023

Related U.S. Application Data
(60) Provisional application No. 63/393,032, filed on Jul. 28, 2022.

(51) Int. Cl. B01J 20/283; B01J 20/28; B01J 20/32; B01J 20/30

(52) U.S. Cl. CPC B01J 20/283; B01J 20/28073; B01J 20/28076; B01J 20/28083; B01J 20/28004; B01J 20/3248; B01J 20/3078; B01J 2220/58

(57) ABSTRACT

Disclosed are methods for thermally treating a particle material which used in a chromatographic separation device. The particle material is thermally treated for purposes of controlling and reducing its porosity. Also disclosed are chromatographic separation devices utilizing the thermally treated particle material of the present invention.

### CROSS-REFERENCE TO RELATED APPLICATIONS

This application is a U.S. Non-provisional patent application, which claims benefit and priority to U.S. Provisional Patent Application No. 63/393,032, filed on Jul. 28, 2022. The content of said application is incorporated herein by reference in its entirety.

### FIELD OF INVENTION

The present invention relates treatment methods for porous particles that are to be incorporated as stationary media in chromatography columns. More specifically, the present disclosure pertains to thermal treatment methods for porous particles used in size exclusion chromatography columns.

### BACKGROUND

Porous particles, such as porous silica particles, are currently considered the prevailing raw material that is used for stationary phases of liquid chromatography separation techniques. Porous silica has been of particular success as media for the stationary phase in chromatographic separation, due to its superior mechanical strength, non-swelling nature and general inertness over a fairly wide range of conditions.

During typical operation, an HPLC (High Performance Liquid Chromatography) separation device includes a solvent that passes through a column filled with an adsorbent media; this media is commonly referred to as the stationary phase. A pump forces the solvent through the column under high pressures (sometimes as high as 15,000-20,000 psi). The advantage of using high pressures to force the solvent through the column is that a particular sample can be tested in much less time than older column chromatography techniques.

More specifically, the column is packed with the particle material, the stationary phase, and the pump forces the solvent and the sample of interest to pass through the stationary phase—during this step, the sample is interacting with the solvent and stationary phase, depending on its chemistry and affinity for the solvent and stationary phase. Generally, most chromatographic separations operate under the same basic principle; every compound interacts with other chemical species in a characteristic manner. Chromatography separates a sample into its constituent components or molecules because of the difference in the affinities or interactive forces of different molecules with the mobile phase, the solvent, and the stationary phase, the packed particles, used in the separation. This causes different elution rates for the various components of the sample, and leads to the separation of the components as they flow out the column at different rates. Typically, the time that it takes for a component to travel through the column will be depended on the strength of the interactions the component has with the stationary phase.

There are, however, chromatographic techniques wherein the prevailing separation principle is the difference in size of the molecules passing through the stationary phase, and not the chemical affinities of the various components. Such is the case in Size Exclusion Chromatography (SEC), as the name suggests. In the case of SEC, the components of a sample of interest are separated on the basis of their molecular size. Differential exclusion or inclusion of the molecules is achieved via filtration through a gel that contains porous spherical particles, within the column. These porous particles have pores of a specific size distribution so as to include or exclude molecules of different sizes when they pass through the porous particles.

SEC has become one of the most popular methods for separation and molecular characterization of natural or synthetic macromolecules mixtures including, monoclonal antibodies, proteins, and polymer molecules. Based on the distribution of the porous particles in the column, small molecules in the sample will diffuse into the pores of the particles, more than larger molecules, and this will result in a slowdown of their movement as they pass through the pores of the particles. In contrast, the larger molecules do not pass through the pores due to their larger size, and hence move more quickly through the stationary phase, and are eluted more quickly. Thus, molecules are separated on the basis of their size by leaving the column in order of decreasing molecular weight.

As the technology in this field has progressed, so have the demands on the equipment. Higher pressure operations and reduced column sizes have been introduced for the purpose of speeding up the run time and obtaining quicker results. Currently, a typical column length is 30-50 mm, with a 2.0-4.6 mm diameter, and the particle sizes used for the stationary phase are below 2.0 μm. A decrease in particle size allows for a decrease in the column length, which in turn results in faster runs and overall time savings, in addition to increased chromatographic resolution.

However, various challenges are present with respect to decreased particle sizes for the stationary phase. Because modern chromatographic equipment is operated at higher pressures than before, the structural and mechanical integrity of the stationary phase particles has become increasingly important. The particles need to be mechanically strong to handle the repeated high pressures they are subjected to during the lifetime of a column. The longevity of the column is directly affected by the stability of the packed particles, and with increased number of runs, the packed particles in the stationary phase can experience particle breakdown.

In particular, with respect to fully porous particles, the structural mechanical stability of the particle is effected by the pore volume present in the particle. As a general principle, the lower the pore volume of a particle the stronger and more stable the particle is under a high pressure environment. Conventional fully porous silica particles that are commonly used in today's chromatographic applications can have a porosity characterized by a pore volume of 1.2-1.8 cc/g. With larger particles, in the 3 μm range, this pore volume does not present significant breakdown issue, as the larger particles are more mechanically stable. However, with smaller particles in the 1.6-1.8 μm range, the mechanical stability is highly affected by the porosity of the particle, as these particles experience breakdown more easily, and thereby affect the lifetime and the result reliability of the column. The porosity of the particles therefore has become an important factor in determining the lifetime of the equipment and the reliability of the results. As such, reducing the porosity of fully porous particles to make them more mechanically stable is of high interest in the industry.

Therefore, a need exists for a process of altering and tailoring the pore volume of particle material, so as to reach an optimal porosity for SEC separations and provide a particle material that has mechanical stability and longer column lifetime.

Additional challenges currently faced by manufacturers of HPLC columns arise partly due to supplier dependent factors. The fully porous silica particles that are readily obtained from suppliers in this field can have a wide range of pore volumes, depending on the characteristics of the batch, and therefore each batch of particles can vary with respect to porosity. This presents issues for manufactures of chromatographic equipment that requires a very specific pore volume for the stationary phase material.

Further challenges are present with respect to the specific porosity available from suppliers of the porous silica particles. A supplier may be able to provide a stock particle material that has, for example, 1.5 cc/g pore volume, but the manufacturer of the separation equipment may require a lower pore volume particle, in order to ensure accuracy of results, prevent premature particle breakdown and decreased column life. The manufacturer therefore has to treat the particles so as to decrease the pore volume to an optimal and desired porosity. Therefore, a need exists for an efficient and reliable process of reducing the pore volume of stock particles to a desired specific pore volume that will enable the manufacturer of chromatographic equipment to provide accurate results, and more importantly, higher mechanical stability of the stationary phase materials, resulting in increased lifetime of the equipment.

There is also a further need for a process of reducing the pore volume of particle material, wherein the process can alleviate the unreliable nature of batch to batch variability by the supplier. Each batch of particles provided by a supplier may have varying characteristics and varying pore volume, which means the manufacturer may have to vary the treatment of the particles to get them to desired pore volume. Therefore, there is a need for an adaptable process for reducing the pore volume of particles, irrespective of the batch characteristics provided by a supplier.

### SUMMARY

The present disclosure relates generally to a method a thermally treating a particle material, to be used in a chromatographic separation device. More specifically, the present disclosure relates to a method for thermally treating a particle material for purposes of controlling the pore volume of the particle material, e.g., reducing the pore volume of the particle material. This reduction in pore volume results in particle materials that are more mechanically stable, experience less breakdown, and in turn result in chromatographic packing materials that have an increased lifetime within a chromatographic column.

In an embodiment of the present invention, a thermal treatment method of a particle material is disclosed. The method in this embodiment incorporates the following steps:
A first heating step wherein the particle material is heated to first temperature. The particle material is held at this at the temperature of the first heating step for about 6 hours.
A second heating step is then carried out wherein the particle material is heated to a second temperature. The particle material is held at the second temperature of this second heating step for about 1 hour.
A third heating step, wherein the particle material is then heated to a third temperature. The particle material is held at the temperature of the third heating step for about 6 hours.

In one embodiment the first temperature is about 120° C. and the second temperature is about 600° C. The third temperature is about 1000° C.-1050° C.

Prior to the being thermally treated the particle material has an initial porosity, and after the thermal treatment method disclosed herein, the particle material will have a final porosity. The final porosity of the particle material is controlled during the third heating step of the method disclosed herein. More specifically, the final porosity of the particles is controlled by varying the temperature in the heating step, so as to arrive at a specific desired final porosity.

In one embodiment of the methods disclosed herein, the final porosity of the particle material can be controlled by a) choosing a desired final porosity, and b) choosing a specific temperature for the third heating step, which will achieve the desired final porosity, and carrying out the third heating step at this chosen temperature.

In one embodiment, the range of the third temperature for the third heating step is about 1000° C.-1050° C. In further embodiments the third temperature range for the third heating step is about 1010° C.-1040° C. In even further embodiments the temperature range is about 1020° C.-1030° C., or any values there between.

In some embodiments of the present invention, the thermal treatment steps disclosed herein also include specific hold and ramp-up times which have been optimized to impart advantageous and desired mechanical and structural stability to the particles. More specifically, during the various heating steps, the following ramp-up times are utilized:
About 30 minutes of total ramp-up time for the first heating step;
About 1 hour of total ramp-up time for the second heating step; and
About 3 hours of total ramp-up time for the third heating step.

The particle material can be comprised of particles having an average diameter size in the range of about 1.0-3.0 μm. In some embodiments, the particle material comprises fully porous SiO2, silica particles.

In certain embodiments, the particle material comprises particles that have a porosity characterized by an initial pore volume in the range of 1.0-1.8 cc/g. When the thermal treatment methods described herein are carried out, the resulting particle material has a reduced porosity characterized by a final pore volume in the range of 0.7 to 1.2 cc/g, or any value there between. In some embodiments, the final pore volume can be reduced in the range of 0.8 to 1.0 cc/g, or any value there between.

The present disclosure further relates to particle materials that have been thermally treated with the methods presented herein. The particle materials disclosed have a reduced pore volume. In certain embodiments the particle materials have a final pore volume in the range of about 0.7 to 1.2 cc/g.

The present disclosure also relates to chromatographic separation devices, particularly Size Exclusion Chromatography (SEC) devices, wherein the packing material used therein contains particle materials, which have been thermally treated according to the currently disclosed methods. The chromatographic separation devices disclosed herein are particularly useful in the analysis of monoclonal antibodies, biosimilars, and other biomolecules.

### Notation and Nomenclature

The term “about” is used in conjunction with numeric values to include normal variations in measurements as expected by persons skilled in the art, and is understood to have the same meaning as “approximately” and to cover a typical margin of error, such as ±15%, ±10%, ±5%, ±1%, ±0.5%, or even ±0.1% of the stated value. The term “about” also encompasses amounts that differ due to different equilibrium conditions for a composition resulting from a particular initial composition. Whether or not modified by the term “about,” the claims include equivalents to the quantities.

It should be noted that, as used in this specification and the appended claims, the singular forms “a,” “an,” and “the” include plural referents unless the content clearly dictates otherwise. Thus, for example, reference to a composition containing “a compound” includes having two or more compounds that are either the same or different from each other. It should also be noted that the term “or” is generally employed in its sense including “and/or” unless the content clearly dictates otherwise. As used herein, “and/or” refers to and encompasses any and all possible combinations of one or more of the associated listed items, as well as the lack of combinations when interpreted in the alternative (“or”).

In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

The term “substantially” is utilized herein to represent the inherent degree of uncertainty that can be attributed to any quantitative comparison, value, measurement, or other representation. The term “substantially” is also utilized herein to represent the degree by which a quantitative representation can vary from a stated reference without resulting in a change in the basic function of the subject matter at issue.

The term “comprise,” “comprises,” and “comprising” as used herein, specify the presence of the stated features, integers, steps, operations, elements, and/or components, but do not preclude the presence or addition of one or more other features, integers, steps, operations, elements, components, and/or groups thereof.

As used herein, the transitional phrase “consisting essentially of” means that the scope of a claim is to be interpreted to encompass the specified materials or steps recited in the claim and those that do not materially affect the basic and novel characteristic(s) of the claimed invention. Thus, the term “consisting essentially of” when used in a claim of this invention is not intended to be interpreted to be equivalent to “comprising.”

The terms “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present disclosure.

As used throughout this description, and in the claims, a list of items joined by the term “at least one of” or “one or more of” can mean any combination of the listed terms. For example, the phrase “at least one of X, Y or Z” can mean X; Y; Z; X and Y; X and Z; Y and Z; or X, Y and Z.

### BRIEF DESCRIPTION OF THE FIGURES

FIG. 1 illustrates a diagram of the steps of the currently disclosed thermal treatment methods.

FIG. 2 is a graphical depiction illustrating the stability over 180 hours of operation of a size exclusion separation column of the present invention, packed with thermally treated, surface modified 1.8 μm size silica particles.

FIG. 3 is a graphical depiction illustrating the stability over 180 hours of a size exclusion separation column of the present invention operated at varying pressures, packed with thermally treated, surface modified 1.8 μm size silica particles.

FIG. 4 is a graphical depiction illustrating the stability of a competitor's SEC column over a period of 160 hours, provided for comparative purposes.

FIG. 5 is a graphical depiction of chromatography results reliability and integrity after 302 runs on a SEC device disclosed in the present invention.

FIG. 6 is a graphical comparison of column stability, comparing Applicant's SEC column and a competitor's SEC column, under extreme running conditions over a period of 100 hours.

### DETAILED DESCRIPTION

Although claimed subject matter will be described in terms of certain embodiments, other embodiments, including embodiments that do not provide all of the benefits and features set forth herein, are also within the scope of this disclosure. Various structural, logical, process step changes may be made without departing from the scope of the disclosure. Accordingly, the scope of the disclosure is defined only by reference to the appended claims.

The following description is presented to enable one of ordinary skill in the art to make and use the disclosure as provided in the context of a particular application and its requirements. Various modifications to the preferred embodiment will be apparent to those with skill in the art, and the general principles defined herein may be applied to other embodiments. Therefore, the present disclosure is not intended to be limited to the particular embodiments shown and described but is to be accorded the widest scope consistent with the principles and novel features disclosed herein.

The present disclosure relates generally to a method a thermally treating a particle material, to be used in a chromatographic separation device. More specifically, the present disclosure relates to a method for thermally treating a particle material for purposes of controlling the pore volume of the particle material, e.g., reducing the pore volume of the particle material. This reduction in pore volume results in particle materials that are more mechanically stable, experience less breakdown, and in turn result in chromatographic packing materials that have an increased lifetime within a chromatographic column.

### Thermal Treatment Methods

In one embodiment of the present invention, a thermal treatment method of a particle material is disclosed. The thermal treatment method comprises:
a first heating step, wherein the particle material is heated to a first temperature;
   holding the particle material at the first temperature of the first heating step for about 6 hours,
a second heating step, wherein the particle material is heated to a second temperature;
   holding the particle material at the second temperature of the second heating step for about 1 hour;
a third heating step, wherein the particle material is heated to a third temperature;
   holding the particle material at the temperature of the third heating step for about 6 hours;
      wherein the particle material has an initial porosity and a final porosity, and wherein the final porosity is controlled during the third heating step.

In one embodiment the first temperature is about 120° C. and the second temperature is about 600° C. The third temperature is about 1000° C.-1050° C.

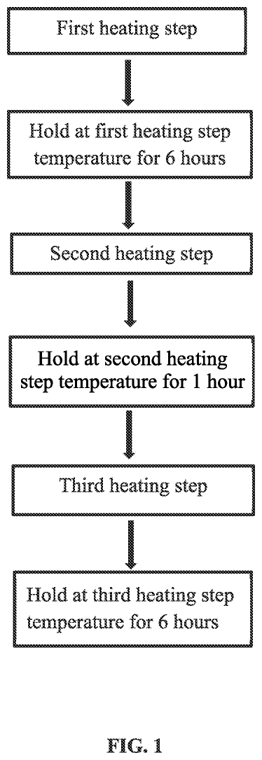

More specifically, a method as depicted in FIG. 1, incorporates the following steps:
A first heating step in which the particle material is heated to a first temperature of about 120° C. The particle material is held at this first temperature of the first heating step for about 6 hours.
A second heating step is then carried out wherein the particle material is heated to a second temperature of about 600° C. The particle material is held at the second temperature of this second heating step for about 1 hour.
A third heating step, wherein the particle material is then heated to a temperature in the range of about 1000° C.-1050° C. The particle material is held at the third temperature of the third heating step for about 6 hours.

Prior to the being thermally treated the particle material has an initial porosity, and after the thermal treatment method disclosed herein, the particle material will have a final porosity. The final porosity of the particle material is controlled during the third heating step of the method disclosed herein. More specifically, the final porosity of the particles is controlled by varying the third temperature in the third heating step, so as to arrive at a specific desired final porosity.

In one embodiment of the methods disclosed herein, the final porosity of the particle material can be controlled by a) choosing a desired final porosity, and b) choosing a specific temperature for the third heating step, which will achieve the desired final porosity, and carrying out the third heating step at this chosen temperature.

In a further embodiment, the third heating step can be repeated if the desired final porosity was not reached. As an example, one may choose a desired final porosity of the particle material by designating a final pore volume of 0.9 cc/g, wherein the initial pore volume of the particles is 1.2. cc/g. The various thermal treatment steps of the method are then carried out, including the first heating step and the second heating step. In the third heating step, a specific temperature is chosen within the disclosed range, e.g., 1020° C. The particle material then undergoes the third heating step at this chosen temperature. The final pore volume of the particle material is measured to identify whether the desired pore volume of 0.9 cc/g was reached. If the desired pore volume was note reached, but only reduced down to 1.0 cc/g, then another, higher temperature can be chosen (e.g. 1030° C.), and another batch is processed and heated to this higher temperature during the third heating step to determine if with the new higher temperature in the third heating step, the desired final pore volume can be reached. This will inform future decisions on how that particular manufacturer's batch is treated, and which temperature will be appropriate for the third heating step, in order to reach the desired final pore volume parameters. Therefore, it is understood that increasing the temperature during the third heating step will result in a reduction in pore volume of the particle material, in comparison to a prior trial. Once the third step heating temperature has been determined and the desired pore volume is reached for that particular batch, the particle material is then ready for any other processing steps required, post thermal treatment, such as a rehydration step and various coatings or surface modifications, prior to being used a stationary phase material in a chromatographic column.

In one embodiment of the present disclosure, a batch of particle material is tested by choosing a specific temperature for the third heating step. The particle material is thermally treated according to the disclosed methods, undergoing a first, second and third heating step, wherein the temperature of the third heating step is chosen, within the range of 1000-1050° C., for example 1025° C. Once the third heating step is completed and cool down of particles has occurred, the final pore volume of the test batch is measured. If the final pore volume obtained by heating at 1025° C. is the desired targeted final pore volume, then the rest of the batch can also be thermally treated with the exact same temperature parameters. However, if the final pore volume is higher than desired, then the rest of the particle batch can be thermally treated, wherein the third step heating temperature is chosen to be higher than 1025° C., so as to obtain a further reduction in final pore volume. Alternatively, if the final pore volume was lower than desired, then a third heating step should be conducted at a lower temperature (i.e., lower than 1025° C.) for the remainder of this particular batch, so that the final pore volume is higher than the test batch, and closer to the desired value.

In an alternate embodiment, for a particular batch of particle material, the thermal treatment method disclosed herein can be carried out by varying the third heating step, while keeping the first and second heating step constant, and creating a reference profile for the third heating step. If for example, for the same batch of particle material that is provided by a supplier, the thermal treatment method is carried for multiple samples of this batch, each at different temperatures for the third heating step (e.g., at 1010° C., 1020° C., 1030° C.). A reference profile of the resulting pore volume is then obtained, and one can then determine based on those results, which specific temperature of the third heating step is appropriate to use for the rest of that batch of particle material, depending on the chosen desired pore volume for the particle material. If the sample which was heated to 1010° C. resulted in a higher than desired pore volume, but the desired pore volume was reached in the sample that was heated to a temperature of 1020° C., then the rest of the batch from that supplier can be thermally treated by choosing 1020° C. for the third heating step.

In one embodiment, the range of temperatures for the third heating step is about 1000° C.-1050° C. In further embodiments the temperature range for the third heating step is about 1010° C.-1040° C. In even further embodiments the temperature range is about 1020° C.-1030° C.

In some embodiments of the present invention, the thermal treatment steps disclosed herein also include specific hold and ramp-up times which have been optimized to impart advantageous and desired mechanical and structural stability to the particles. More specifically, during the various heating steps, the following ramp-up times are utilized:
about 30 minutes of total ramp-up time for the first heating step;
about 1 hour of total ramp-up time for the second heating step; and
about 3 hours of total ramp-up time for the third heating step.

For purposes of this disclosure “ramp-up time” is used to describe the time between the beginning of the heating step and a time where the desired temperature of that step is reached. Therefore, in the first heating step, the particle material is heated from ambient temperature to a temperate of about 120° C., wherein the final temperature is reached in about 30 minutes. It is envisioned that the ramp-up times disclosed herein can vary in a range of 10-20% of disclosed values, with similar results reached in the disclosed method. The various heating steps and ramp-up times disclosed herein are chosen and optimized so as to ensure that the thermal treatment process that will not disturb the stability and structure of the particle material.

In one embodiment of the present invention, the particle material comprises SiO2, silica particles. The particle material can be comprised of particles having an average diameter size in the range of about 1.0-3.0 μm. In one embodiment, the average particle diameter is in the range of about 1.2-2.8 μm. In a further embodiment, the average particle diameter is in the range of about 1.4-2.6 μm. In another embodiment, the average particle diameter is in the range of about 1.6-2.4 μm. In a further embodiment, the average particle diameter is in the range of about 1.8-2.2 μm. In an even further embodiment, the average particle diameter is in the range of about 2.0-2.2 μm. In a particular embodiment the average particle diameter is 1.8 μm. In another embodiment the average particle diameter is 3.0 μm.

In some embodiments, the particle material comprises particles that have a porosity characterized by an initial pore volume in the range of 1.0-1.8 cc/g. In other embodiments, the initial pore volume is in the range of 1.1-1.7 cc/g, or any value therebetween. In further embodiments the initial pore volume is in the range of 1.2-1.6 cc/g, 1.3-1.5 cc/g, or any value therebetween. In other embodiments, the pore volume is in the range of 1.45-1.65 cc/g.

When the thermal treatment methods described herein are carried out, the resulting particle material has a reduced porosity characterized by a final pore volume in the range of 0.7 to 1.2 cc/g, or any value therebetween. In some embodiments, the final pore volume can be reduced in the range of 0.8 to 1.0 cc/g, or any value therebetween. The level of reduction that is achievable through the disclosed methods will depend on the initial pore volume. For example, if starting out with a pore volume of 1.2 cc/g, carrying out the thermal treatment method can result in a pore volume reduction to 0.8 cc/g, depending on the specific temperature point chosen in the third heating step. If starting out with a higher pore volume, e.g., 1.5 cc/g, then carrying out the methods described herein may reduce the pore volume down to 1.0 cc/g, again depending on the temperature point used in the third heating step. If a higher temperature point is used, one can expect that further pore reduction will occur, than when a lower temperature point is chosen. In other words, the temperature which will be chosen for the third heating step, will depend on the initial pore volume of the batch, and the desired target final pore volume.

In some embodiments the particle material is characterized by an initial porosity, wherein an average initial pore size in the range of 225-280 Angstroms. In further embodiments the initial average pore size is in the range of 255-275 Angstroms, or 260-270 Angstroms, or any value therebetween.

After the thermal treatment methods of the present invention are carried out, the particle materials will have a final porosity characterized by a final average pore size in the range of 195-270 Angstroms (A), or 200-265 A, or 205-260 A, or 210-2255 A, or 215-250 A, 220-245 A, 225-240 A, 230-235 A, or any value therebetween.

Tables 1 and 2 below, outline various exemplary parameters obtained once the particle materials have undergone the thermal treatment methods disclosed herein. In Table 1, the final pore diameter, final internal pore surface area, and final pore volumes are outlined for silica particles having an average particle diameter of 1.8 μm. The disclosed ranges in the tables below can have a natural variation of about 10% in terms of the disclosed values.

TABLE 1

| | Unit of | |
|---|---|---|
| Parameter | Measure | Specification |
| Silica Visual | N/A | White, free flowing powder. No |
| Assessment | | visual clumps or aggregation |
| Particle Size | μm | 1.7-1.9 |
| Particle Distribution | N/A | ≤1.7 |
| Pore Diameter | A | 195-225 |
| Surface Area | m²/g | 160-190 |
| Pore Volume | cm³/g | 0.82-1.00 |

In Table 2, the final pore diameter, final internal pore surface area, and final pore volumes are outlined for silica particles having an average particle diameter of 3.0 μm.

TABLE 2

| | Unit of | |
|---|---|---|
| Parameter | Measure | Specification |
| Silica Visual | N/A | White, free flowing powder. No |
| Assessment | | visual clumps or aggregation |
| Particle Size | μm | 2.7-3.0 |
| Particle Distribution | N/A | ≤1.6 |
| Pore Diameter | A | 240-270 |
| Surface Area | m²/g | 145-185 |
| Pore Volume | cm³/g | 0.90-1.20 |

### Evolution of Pore Morphology

With respect to silica particle material, the thermal treatment methods disclosed herein have various effects on the pore morphology and surface chemistry of the particles depending on the stages of heating. Understanding what is occurring during the various heating steps, provides a clearer understanding of this process overall. It is believed that during the second heating step, which in the present method is at a temperature of about 600° C., a dehydroxylation process is occurring. The surface of silica particles contains silanol groups (Si—OH), which can be removed upon thermal processing, typically in temperatures higher than 400° C., through the process of dehydroxylation. During this process, the bonds of the OH group and a hydrogen from an adjacent silanol break away to form water as a result of a condensation reaction. This gives rise to siloxane Si—O—Si bridges. However, it is believed that in this temperature range, not all the silanol groups are dehydroxylated, and some do remain on the surface of the silica particle itself and within the pores of the particles. During the third heating step of the current method, further secondary dehydroxylation processes occurs, in which remaining silanol groups are removed and further siloxane bridges are formed on the surface of the particles and in the pores. This heating step is carried out at higher temperatures, in the range of 1000° C.-1050° C. At these temperatures, the silanol groups are entirely removed, and the resulting siloxane bridges (Si—O—Si) forming inside the pores at the pore-solid interfaces likely give rise to rougher pore-solid interfaces and decreased the internal pore dimensions, thereby decreasing the pore size and pore volume.

### EXAMPLES

The following examples and results will further illustrate and describe the present invention. The following examples are non-limiting illustrations of the thermal treatment methods and the thermally modified particle materials obtained through the disclosed methods.

To further understand the impact of the thermal treatment methods of the present invention, tests were carried out using the disclosed methods. The results and parameters of these tests are represented in Table 3 below.

### Example 1

Silica particles were provided by a supplier, having an initial surface area (m2/g) and initial pore volume (cc/g) and an initial pore size (Angstroms). In Trial 1, as can be seen in Table 3 raw silica particles were used having an initial internal pore surface area of 247 m2/g, the initial average pore volume of 1.61 cc/g and the initial average pore size of 274 Angstroms. The raw silica were dispersed in acetone (4 times v/w), i.e. 4 mL of acetone per 1 gram of silica particles. This dispersion was then poured on a Buchner funnel having a filter and the liquid was allowed to pass through, to provide raw silica particles cake. The filtered cake was again treated with acetone, in the same amount as the first step (4 ml of acetone per 1 gram of silica particles). The acetone filtered through the Buchner funnel and the cake was allowed to dry. This washing and drying pre-processing step is conducted for purposes of removing water particles or surfactants from the surface of the silica particles. The particle material was then placed in a convection oven for 16 hours and heated at 80° C. The raw silica particles were then thermally treated with the methods of the present invention. A first heating step was carried out, where the silica particles were heated to a temperature of 120° C., with a ramp-up time of 30 minutes from ambient temperature to 120° C. The particles were held at this temperature for 6 hours. A second heating step was carried out at 600° C. The ramp-up time from 120° C. to 600° C. was 1 hour. The particles were held at this temperature for about 3 hours. A third heating step was then carried out at a temperature of 1040° C., having a total ramp-up time from 600° C. to 1040° C. of about 3 hours. The particles were held at the heating temperature of 1040° C. for 6 hours. After this the particles were allowed to cool to ambient temperature.

As can be seen by Trial #1 in Table 3, heating the particles according to the treatment method of the present invention, to a temperature of 1040° C. in the third heating step, resulted in a decrease of pore volume, with a final pore volume of 0.91 cc/g, and a decreased final pore size of 195 Angstroms, and decreased final internal pore surface area of 176 m²/g.

TABLE 3

| | Raw | | | Thermally treated silica particles | | | | |
|---|---|---|---|---|---|---|---|---|
| | silica particles | | | | | | | Temp of |
| Trial | S.A | P.V. | P.S. | S.A | P.V. | P.S. | Wt. | third heating |
| # | (m2/g) | (cc/g) | (A) | (m2/g) | (cc/g) | (A) | (g) | step |
| 1 | 247 | 1.61 | 274 | 176 | 0.91 | 195 | 150 | 1040° C. |
| 2 | 247 | 1.61 | 274 | 177 | 0.93 | 198 | 300 | 1040° C. |
| 3 | 242 | 1.57 | 272 | 175 | 0.92 | 200 | 150 | 1025° C. |
| 4 | 246 | 1.6 | 272 | 167 | 0.87 | 204 | 150 | 1030° C. |
| 5 | 242 | 1.57 | 272 | 177 | 0.93 | 201 | 300 | 1025° C. |
| 6 | 231 | 1.48 | 274 | 175 | 1.1 | 243 | 300 | 1015° C. |
| 7 | 231 | 1.48 | 274 | 159 | 0.96 | 238 | 400 | 1020° C. |

### Example 2

In Trial #5, shown in Table 3 above, the raw silica particles were pretreated with the acetone treatment step and filtered in the exact same method as disclosed in Example 1. The silica particles in this trial had an initial pore volume of 1.57 cc/g, and an initial pore size of 272 Angstroms. The thermal treatment method was carried out with the same temperature and ramp-up times for the first heating step and second heating step, as disclosed in Example 1. In the third heating step however, this particle batch was heated to a temperature of 1025° C. and held at this temperature for 6 hours. This particular temperature point in the third heating step resulted in a final pore volume if 0.93 cc/g and final pore size of 201 Angstroms, as shown in Table 3.

When comparing Trial #1 and Trial #5, its notable that the raw silica particles of Trial #1 were heated to a higher temperature in the third heating step (1040° C. vs. 1025° C.). This likely accounts for the differences in the reduction of pore volume of these respective Trials. In Trial #1, the third heating step temperature was 1040° C., which resulted in a reduction of pore volume from 1.61 cc/g to 0.91 cc/g. In Trial #5 the temperature was 1025° C., resulting in a change in pore volume was from 1.57 cc/g to 0.93 cc/g. The heating temperature of 1025° C. did not achieve a final pore volume as low as was achieved with heating at 1040° C., despite starting with a lower initial pore volume (1.57 cc/g vs. 1.61 cc/g). These results lead to the conclusion that the higher the temperature in the third heating step, the higher the reduction in pore volume that can be achieved. It is to be understood however, that beyond the disclosed range of 1000-1050° C., if heating is conducted above 1050° C. then a full densification of the silica particles will result, and this is not desired for the chromatographic separation techniques that are the subject of this disclosure.

### Example 3

Trial #6 was carried out similarly to the method steps detailed in Examples 1 and 2 above. The raw silica particles of this trial had an initial pore volume of 1.48 cc/g, and initial pore size of 274 Angstroms. An acetone treatment step and a first and second heating step were carried out as disclosed in previous examples, with the same temperatures and ramp-up and hold times. The third heating step for this trial was conducted at a temperature of 1015° C., the particles being heated at this temperature for about 6 hours. The resulting final pore volume was 1.1 cc/g.

The same batch of raw silica as in Trial #6 was also tested in Trial #7, albeit in Trial #7 the third heating step temperature was higher, 1020° C. All other parameters of this trial remained the same as in Trial #6, including the same batch of raw silica particles, having the same, initial porosity and size parameters, and undergoing the same treatment steps, until the third heating step. The third heating step was the only variation between these trials. As can be seen by the results in Table 1, a higher reduction in pore volume achieved in Trial #7, due to the higher temperatures used in the third heating step. The final pore volume of Trial #6 was 1.1 cc/g (1015° C.), whereas the final pore volume achieved in Trial #7 was 0.96 cc/g (1020° C.). These results show that even a slight variation in the third heating step, i.e., a temperature of 1020° C. vs. 1015° C., (a 5° C. difference) will have a significant impact in the amount of pore volume reduction that can be achieved (1.1 vs. 0.96 cc/g).

If several trials are carried out on the same batch, having the same raw silica characteristics, then a reference profile can be created, by thermally treating the same batch to various third step heating temperatures, and analyzing the final pore volume values of the particles. This can then determine which specific temperature is appropriate in the third heating step, to achieve the target desired final pore volume value.

Hence, the thermal treatment methods disclosed herein are adaptive. The supply of raw silica particles obtained can vary batch by batch and will not necessarily have the same pore contraction rate during heating, even if the measurement parameters reported by the supplier may be the same. Because each batch has variability in heat contraction characteristics, it is important to conduct the thermal methods disclosed for each batch received, then determine an appropriate third heating step temperature to treat the remainder of that batch. Through this method, a high degree of continuity and reliability can be achieved with respect to the final product pore volume and pore size of the particles, the characteristics of which are crucial for the stationary phase materials for chromatographic separation.

### Thermally Treated Particle Materials

The present invention further relates to the particle materials, which have been thermally treated by the methods disclosed herein. In some embodiments, the particle materials are fully porous materials. In further embodiments, the particle materials are fully porous SiO2, silica, particles.

In certain embodiments, the particle materials disclosed herein are comprised of particles having an average diameter size in the range of about 1.0-3.0 μm, or any value therebetween. In one embodiment, the particle diameter is in the range of about 1.2-2.8 μm. In a further embodiment, the particle diameter is in the range of about 1.4-2.6 μm. In another embodiment, the particle diameter is in the range of about 1.6-2.4 μm. In a further embodiment, the particle diameter is in the range of about 1.8-2.2 μm. In an even further embodiment, the particle diameter is in the range of about 2.0-2.2 μm. In an exemplary embodiment the particle materials have an average particle diameter of about 1.6 μm, or about 1.8 μm, or 3.0 μm.

In some embodiments, the particle material comprises particles that have a porosity characterized by an initial pore volume in the range of 1.0-1.8 cc/g. In other embodiments, the initial pore volume is in the range of 1.1-1.7 cc/g, or any value therebetween. In further embodiments the initial pore volume is in the range of 1.2-1.6 cc/g, 1.3-1.5 cc/g, or any value therebetween.

The particle materials of the present disclosure, when thermally treated with the methods disclosed above, have a final porosity that is characterized by a final pore volume. In certain embodiments the particle materials have a final pore volume in the range of about 0.7 to 1.2 cc/g, or any value therebetween. In some embodiments, the final pore volume is about 0.8 to 1.0 cc/g, or any value therebetween. In further embodiments, the final pore volume is about 0.9 cc/g.

After the thermal treatment methods have been carried out, a hydrating step can be performed on the thermally treated particle materials. The step of hydrating the thermally treated particle material is carried out so as to reintroduce functionality to the surface of the particle material, for further chemical bonding that will occur during the subsequent coating step. Since —OH groups are removed during the dehydroxylation reactions occurring in the thermal treatment of the particle material, once the pore reduction has taken place, some —OH groups need to be reintroduced on the surface of the silica particles so that the hydrophilic substance used in the coating step has a reaction site to bond to on the surface of the silica particle.

Therefore, in one embodiment of the present invention, the thermally treated porous particle material, now having a reduced pore volume, undergoes a hydrating step wherein the porous particle material is sonicated with water for a period of time, then this aqueous particle mixture is added to a reactor and refluxed with a hydrofluoric acid (HF) solution. In the case of silica particles, Hydrofluoric acid solution breaks up strong Si—O bonds on the surface of the silica particles, and this allows for available reaction sites in a subsequent coating step.

Once this hydrating step is completed, the particle material has post-hydration parameters which include a post-hydration pore volume (cc/g) and post hydration pore sizes (Angstroms), examples of which are shown in Table 4 below. Table 1 outlines various particle material parameters, including the incoming raw silica particle initial pore volumes (P.V), initial pore size (P.S) and initial internal pore surface areas (S.A). Table 1 also details the parameters once the pore reduction thermal treatment step is completed, followed by the measured parameters once the hydrating step is completed.

TABLE 4

| | Raw | | | Thermally treated | | | Hydrated silica | |
|---|---|---|---|---|---|---|---|---|
| | silica particles | | | silica particles | | | particles | |
| Trial | S.A | P.V. | P.S. | S.A | P.V. | P.S. | P.V. | P.S. |
| # | (m2/g) | (cc/g) | (A) | (m2/g) | (cc/g) | (A) | (cc/g) | (A) |
| 1 | 247 | 1.61 | 274 | 176 | 0.91 | 195 | 0.94 | 206 |
| 2 | 247 | 1.61 | 274 | 177 | 0.93 | 198 | 0.94 | 208 |
| 3 | 242 | 1.57 | 272 | 175 | 0.92 | 200 | 0.91 | 208 |
| 4 | 246 | 1.6 | 272 | 167 | 0.87 | 204 | 0.87 | 205 |
| 5 | 242 | 1.57 | 272 | 177 | 0.93 | 201 | 0.95 | 214 |
| 6 | 231 | 1.48 | 274 | 175 | 1.1 | 243 | 1.08 | 259 |
| 7 | 231 | 1.48 | 274 | 159 | 0.96 | 238 | 0.98 | 249 |

Once the hydrating step has been completed the silica particle material can the processed with a coating step. The coating step is carried out so as to ensure that the surface functionality of the particle material is such that ion exchange interactions and reverse phase interactions are prevented during the time that the sample interacts with the particle material within a separation column.

In one embodiment the thermally treated particle materials disclosed herein further comprise a surface coating. In some embodiments this surface coating can be a hydrophilic coating. In further embodiments the hydrophilic coating can be a diol silane coating. In further embodiments, the particle materials comprise surface-modified silica particles, such that the surface modifications prevent the various components in the sample from interacting with the surface of the silica particles.

In one embodiment the coating step uses a very hydrophilic silane compound as a reagent for conducting the coating step on the silica particles. This hydrophilic silane has multiple —OH groups and results in the surface of the silica particle becoming similar to the water mobile phase, thereby reducing chemical interactions with the molecules contained within the sample. The silane coating also ensures that the silanol groups remaining on the silica surface are neutralized and do not have an ion exchange interactions with the molecules of interest contained in the sample to be tested. The coating steps in the present method are carried out simply in the presence of water, with the aid of an acidic catalyst. Prior silane coatings known in the art have been synthesized in Toluene, however the inventors of the present invention have surprisingly discovered that this step can instead be carried out simply in an aqueous mixture with a catalyst.

In an embodiment of the present disclosure the step of coating the porous particle material with a hydrophilic compound can comprise:
a. preparing an aqueous mixture comprising a catalyst;
b. adding the hydrophilic compound to the aqueous mixture;
c. adding the porous particle material to the mixture of step b) and reacting the hydrophilic compound with porous particle material to form a coating on the porous particle material and obtain a surface modified porous particle material.

In some embodiments, the catalyst is an acidic compound. In one embodiment the acidic compound is hydrochloric acid (HCl). In this particular embodiment the HCl is used in a concentration of 0.1 N HCl. N represents Normality, which is another way to quantify solution concentration. It is similar to molarity but uses the gram-equivalent weight of a solute in its expression of solute amount in a liter (L) of solution, rather than the gram molecular weight (GMW) expressed in molarity.

The hydrophilic compound added to the aqueous mixture containing the catalyst can be a very hydrophilic silane compound. In one particular embodiment, the hydrophilic silane compound is glycidoxypropyltrimethoxysilane (GTMPS). When GTMPS is added to the aqueous solution, this causes a hydrolysis of the GTMPS resulting in a hydrolyzed GTMPS, which can more easily adsorb and react with the silica surface.

The porous particle material, i.e. the porous silica particles, are then added to the aqueous mixture containing the GTMPS and allowed to react for a period of about 12 hours at a temperature of about 100° C. During this reaction, the GTMPS is adsorbing on the surface of the silica particles, in a silylation reaction. The silylation of the silica surface by GTMPS significantly reduces the number of charged surface groups and silanol groups on the silica particles. GTMPS binds covalently to the silica surface and the epoxy ring on GTMPS opens and transforms into a diol (this can also be referred to a as diol bonded phase). The more GTMPS that is added to the aqueous solution, the higher degree of silylation that can occur, and hence the thicker the coating on the surface of the silica particles. The thickness of the coating can be analyzed base on % Carbon reading. This can be measured by an elemental analyzer. In some embodiments the % Carbon value of the coatings is between 3.0-7.0% Carbon.

In one embodiment the step of coating the porous particle material with a hydrophilic compound comprises combining the reaction solvents and reagents in the following specific amounts:
a. mixing 6× amount of water with 0.1× amount of catalyst;
b. adding ⅓× amount of hydrophilic compound to the water and catalyst mixture;
c. reacting the hydrophilic compound with 1× of the porous particle material, to obtain a surface modified porous particle material.

The value X represents the amount porous particle material by weight. The following example illustrates in more detail the coating procedure that is performed on the porous particle material.

### Example 4

In a beaker, 6× of deionized water was added along with 0.1× of 0.1 N HCl (less than 6 months old) to the beaker. This mixture was then stirred. The pH of this mixture is monitored. The pH reading is close to a pH value of 2.75-3.0. The mixture is then placed in a reactor, and the reactor temperature is set to 25 C. Once the temperature of the mixture is stabilized and reading in the range of 25-30° C., ⅓× by volume of GTMPS is added to the mixture of water and HCl. The resulting mixture is stirred and the temperature is monitored. There will be a momentary temperature rise (in the range of 1.5-4° C.) due to exothermic reactions occurring. The mixture turns opaque, but becomes clear after about 10 minutes. Once the mixture is clear X grams of silica particles are added. The temperature set point of the reactor is set to 100° C., with a ramp up function of 50° C. per hour, and the reaction is allowed to proceed for a period of about 12 hours. The silica particles used in this example are 1.8 um sized particles that have previously undergone a pore reduction thermal treatment step and a hydrating step. Once the reaction has completed, the silica particles undergo a washing step, using filter paper and a Buchner funnel. 10× amount of deionized water is used to wash the silica particles, followed by 5× amount of methanol. The silica particles are then allowed to dry in an 80° C. environment for a period of 8 hours. Subsequently an Elemental Analyzer is used to measure the % Carbon of the silica particles, so that the silane coating on the particles can be quantified.

After the coating step is completed, the resultant particles are now silane coated silica particles with diol surface modifications, that allow for a reduction in ion exchange and reverse phase interactions with the molecules in the samples to be tested. The surface modifications that occur due to the silane coating make the silica particles have a surface functionality similar to water, hence making the packing materials surface chemistry similar to the mobile phase chemistry. Thus any interactions that occur between the sample and the packing materials are now solely due to size exclusion principles and are not altered by non-size dependent factors and interactions, such as adsorption of the molecule with reactive silanol groups on the surface of the particles. Because the silica particles are now diol modified surfaces, or diol bonded phase particles, they no longer have negatively charged silanol groups on the surface, that can interfere with the retention times of the analytes of interest. The diol ligand covers the silica surfaces as well as displays a polar functionality that mimics water, thereby rendering the surface of the silica particles similar to the aqueous mobile phase that are carrying the analyte/molecules past and through the stationary phase packing material.

The particle materials disclosed here are thermally treated and optimized in terms of porosity, for their use in chromatographic separation devices. In certain embodiments, the particle materials are used as stationary phase materials in Size Exclusion Chromatography (SEC) separation devices. In further embodiments, the particles materials are used in SEC devices which are Gel Filtration Chromatography Devices (GFC).

### Chromatographic Separation Devices

The present disclosure further relates to chromatographic separation devices, particularly SEC devices, wherein the packing material used therein contains particle materials, which have been thermally treated according to the currently disclosed methods.

The chromatographic separation devices disclosed herein are particularly useful in the analysis of monoclonal antibodies, biosimilars, and other biomolecules.

In one embodiment, a chromatographic separation device is disclosed, which comprises:
at least one columnar member having an inner void;
at least one stationary packing material within the inner void;
wherein the stationary packing material comprises thermally treated particle material, according to the methods disclosed above.

In certain embodiments, the stationary packing material comprises silica particles, having an average pore volume of about 0.7 to 1.2 cc/g. In another embodiment, the silica particles have an average pore volume of about 0.8 to 1.0 cc/g. In a further embodiment, the silica particles have an average pore volume of about 0.9 cc/g.

In some embodiments, the chromatographic separation device is a Size Exclusion Chromatography (SEC) device or a Gel Filtration Chromatography device (GFC). GFC is used to separate large macromolecules such as antibodies, immunoglobulins, protein complexes, protein aggregates, peptides, and other biomolecules. In gel filtration chromatography, the compounds of interest in the sample move and filter through the stationary phase based on their molecular size. Typically aqueous solvents are used in the mobile phase to ensure that the compound of interest maintains biological integrity. Gel filtration columns can separate biomolecules that range from 200 to 1,500,000 Daltons in size. Gel filtration chromatography columns require a GFC stationary packing material that has low surface activity, high efficiency, and consistent uniform pore size.

In some embodiments, the columnar member of the chromatographic separation device has length of 150 mm, or 300 mm.

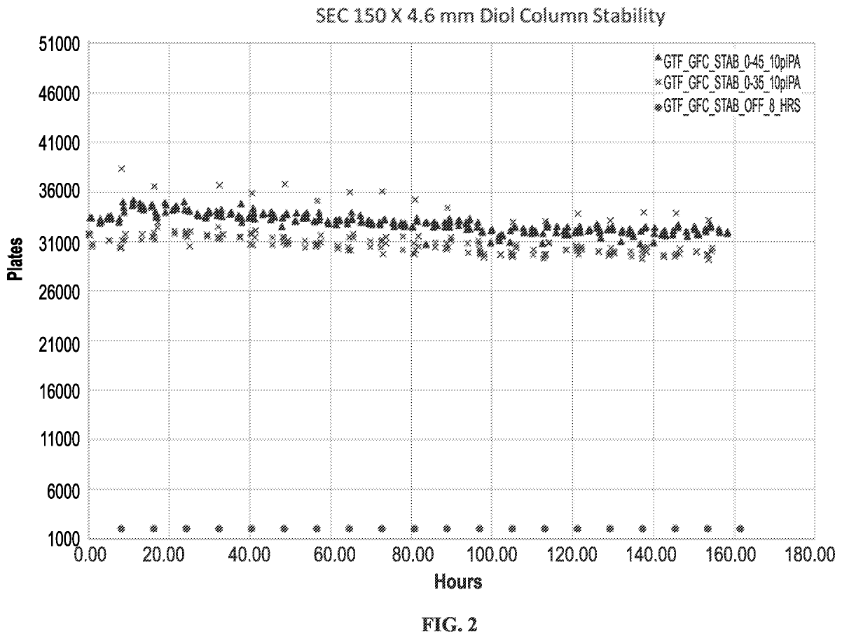

The columnar member has an inner void with an inner diameter of 2.1 mm, or 3.0 mm, or 4.6 mm, or 7.8 mm, wherein the porous packing material of the present invention is housed. The particle size for the stationary packing material housed in the columnar member can vary between 1.6-3.0 μm. In some embodiments, the average particle size of the packing material is about 1.8 μm, and in other embodiments a packing material having a 3.0 μm is used. This will depend on the type of analyte to be tested, and the size of the molecules of interest, in addition to the column size parameters. As disclosed above, the porous packing material within the columnar member of the separation device has a reduced pore volume, which results in increased stability of the packing material and increased lifetime of the columnar member of the chromatographic separation devices disclosed herein. Moving now to FIG. 2, the stability of a chromatographic devices disclosed herein (SEC device) containing the thermally treated particle materials as stationary phase, is graphically depicted. Column stability is shown in terms of theoretical Plates (N) graphed against 180 hours of operation. Theoretical plate number (N) is an index that indicates column efficiency. It describes the number of plates as defined according to plate theory, and can be used to determine column efficiency based on calculation in which the larger the theoretical plate number the sharper the peaks.

The SEC column was packed with thermally treated low pore volume, surface modified 1.8 micron size silica particles as the stationary media, with a packing pressure of 20,000 PSI. The column dimensions of this particular device were 150 mm length and 4.6 mm in diameter. The mobile phase flow rate for the runs depicted in this graph are 0.35 mL/min and 0.45 mL/min. Injected samples contained 50 ug/ml Uridine, with an injection volume of 0.7 μL. A combination of buffers was used with the aqueous mobile phase, 0.1 M NaPO4 and 10% Isopropanol.

As can be seen in FIG. 2, the column efficiency is maintained fairly steadily within 160 hours of operation of runs in various flow rate conditions described above. The theoretical plate index drops a minimal amount over the 160 hours of operation, which signifies that the stationary phase packing materials disclosed herein are able to maintain their stability and hence the stability and of the column itself, under high pressure conditions, over a long operation time.

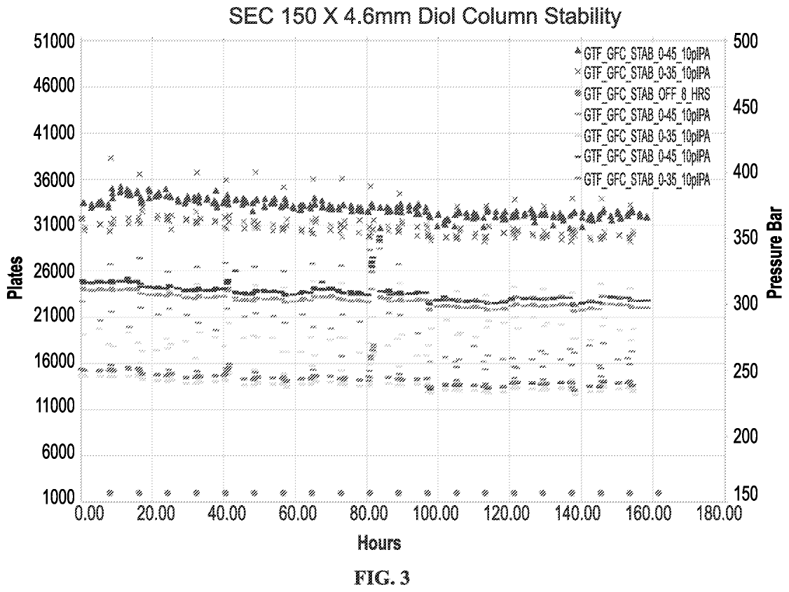

FIG. 3 similarly depicts the same sample runs as described above, performed at 0.35 mL/min and 0.45 mL/min, and with varied column pressures, as can be seen by the Y axis on the right side of the graph, showing a pressure range of 150 to 500 bar. Again here, the plate efficiency over 160 hours of runs, at the various flow rate and pressure conditions shown in the graph, has remained fairly steady with only a slight drop in Plates over 160 hours of operation. These results signify a high level of stability of the packing materials and a high degree of reliability of results.

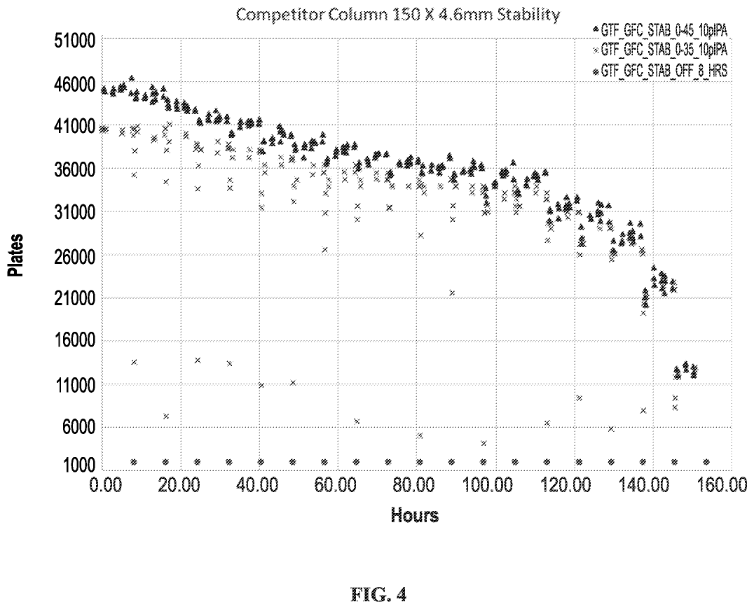

When compared to competitor SEC columns, the SEC devices designed and operated with the thermally treated particle materials disclosed herein show a high degree of superiority in terms of column stability. This is further exemplified by FIG. 4, wherein a competitor column was tested, under the same conditions as those disclosed for the runs depicted in FIGS. 2 and 3. The same samples were run under the exact same conditions and buffer concentrations. The flow rates of the mobile phase tested were 0.35 mL/min and 0.45 mL/min, the injected samples contained 50 μg/ml Uridine, with an injection volume of 0.7 μL. The column stability of the competitor column was greatly diminished under operation to 150 hours. As can be seen by the data charted in the graph, the Plate efficiency dropped considerably beginning as early as 30-40 hours of operation. Whereas the SEC columns of the present invention, utilizing the disclosed reduced pore volume packing materials, maintained a nearly steady Plate efficiency even at 160 hours of operation.

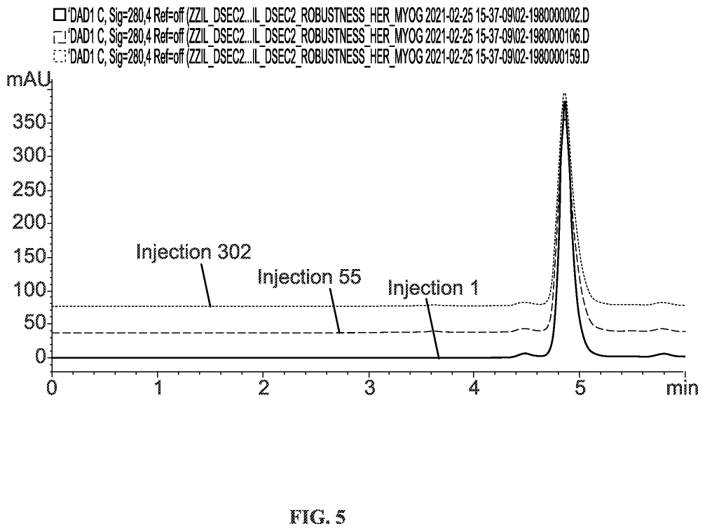

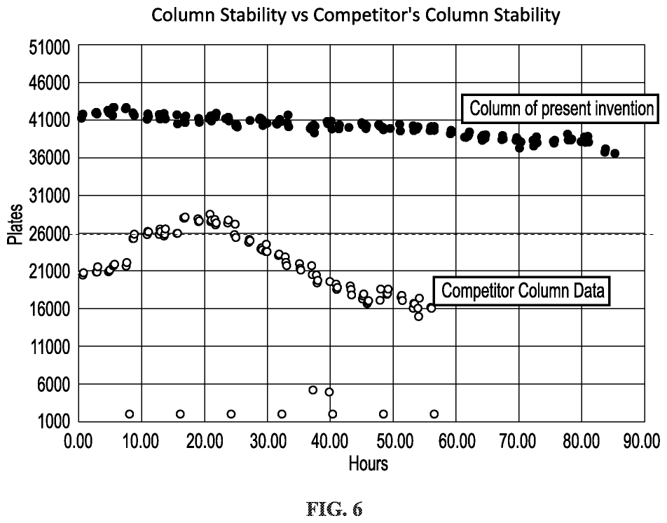

As can be seen in FIG. 5, the reduced pore volume silica particles of the present invention when loaded into the SEC columns of the present disclosure result in improved column lifetime and performance stability. FIG. 5 shows, three samples, Injection 1, Injection 55 and Injection 302, corresponding to the first, the 55th and the 302nd injection, respectively. As shown in FIG. 5, the output performance of the SEC column remains unchanged after 302 injections. Comparing the samples shown in FIG. 5, it is evident that the elution time and peak volume of the samples is the same for the first and the 302nd injection. This shows superior performance to existing and known columns, which typically experience column failure within 150-200 injections. This increased lifetime and stability of the column directly results from the increased mechanical robustness and stability of the reduced pore volume silica particles of the present invention. The thermally treated, low pore volume, surface modified packing materials disclosed here, provide stationary phase materials which are less prone to early mechanical failure. When these packing materials are incorporated in SEC devices disclosed here, they yield separation devices with significantly increased lifetime and which maintain results integrity over much longer number of runs than currently available SEC columns. This is further demonstrated in FIG. 6, which shows unchanged performance efficiency after 90 hours of extreme running conditions for SEC columns of the present invention. A currently existing SEC column from a competitor was compared to an SEC column of the present invention. As can be seen by the results depicted in FIG. 6, the SEC column of the present invention had less than a 10% decrease in Plates (N), whereas the SEC competitor column of experienced a sharp decline in column efficiency beginning after 30 hours and eventually experience column failure within 50 hours of extreme running conditions. The standard commonly used silica packing materials of competitor's column cannot withstand rigorous running conditions, which leads to erratic results and eventually formation of a column “void”, and premature column failure. This is not the case with the SEC columns of the present invention, using the reduced pore volume silica particles disclosed here. As can be seen in FIG. 5 there is at least a 50% increase in column stability, as compared to the commonly used SEC column packing materials.

Although the present disclosure has been described with respect to one or more particle embodiments, it will be understood that other embodiments of the present disclosure may be made without departing from the scope of the present invention. Hence the present disclosure is deemed limited only by the appended claims.

Other embodiments are enumerated in the following clauses:
1. A thermal treatment method of a particle material, comprising:
a first heating step, wherein the particle material is heated to a first temperature;
   holding the particle material at the first temperature of the first heating step for about 6 hours,
a second heating step, wherein the particle material is heated to a second temperature;
   holding the particle material at the second temperature of the second heating step for about 1 hour;
a third heating step, wherein the particle material is heated to a third temperature;
   holding the particle material at the temperature of the third heating step for about 6 hours;
      wherein the particle material has an initial porosity and a final porosity, and wherein the final porosity is controlled during the third heating step.
2. The thermal treatment method of clause 1, wherein the first temperature is about 120° C. and the second temperature is about 600° C.
3. The thermal treatment method of clause 1, wherein the third temperature is about 1000° C.-1050° C.
4. The thermal treatment method of clause 1, wherein the final porosity is controlled by varying the temperature in the third heating step.
5. The thermal treatment method of clause 1, wherein controlling the final porosity comprises:
a) choosing a desired final porosity, and
b) choosing a specific temperature of the third heating step.
6. The thermal treatment method of clause 5, further comprising repeating the thermal treatment method and choosing a different specific temperature in the third heating step if the desired final porosity is not reached.
7. The thermal treatment method of clause 1, further comprising:
a. about 30 minutes of total ramp-up time for the first heating step;
b. about 1 hour of total ramp-up time for the second heating step; and c. about 3 hours of total ramp-up time for the third heating step.
8. The thermal treatment method of clause 1, wherein the temperature of the third heating step is about 1010° C.-1040° C.
9. The thermal treatment method of clause 1, wherein the temperature of the third heating step is about 1020° C.-1030° C.
10. The thermal treatment method of clause 1, wherein the final porosity of the particle material is lower than the initial porosity.
11. The thermal treatment of clause 1, wherein the initial porosity comprises an initial pore volume and the final porosity comprises a final pore volume, wherein the final pore volume is lower than the initial pore volume.
12. The thermal treatment of clause 11, wherein the initial pore volume of the particle material is about 1.0-1.8 cc/g.
13. The thermal treatment method of clause 9, wherein the initial pore volume of the particle material is about 1.2-1.6 cc/g.
14. The thermal treatment method of clause 9, wherein the final pore volume of the particle material is about 0.7 to 1.2 cc/g.
15. The thermal treatment method of clause 9, wherein the final pore volume of the particle material is about 0.8 to 1.0 cc/g.
16. The thermal treatment method of clause 9, wherein the initial porosity comprises an average initial pore size of about 225-280 Angstroms.
17. The thermal treatment method of clause 9, wherein the final porosity comprises an average final pore size of about 195-270 Angstroms.
18. The thermal treatment method of clause 1, wherein the particle material comprises SIO2 particles.
19. The thermal treatment method of clause 1, wherein the particle material comprises particles with an average particle diameter of about 1.2 to 3.0 μm.
20. The thermal treatment method of clause 1, wherein the particle material comprises fully porous particles.
21. The thermal treatment method of clause 1, wherein the particle material comprises particles used in chromatographic separation.
22. The thermal treatment method of clause 21, wherein the separation device is a size exclusion chromatographic device.
23. A thermally treated particle material, according to the method of claim 1.
24. The thermally treated particle material of clause 23, wherein the particle material comprises silica particles.
25. The thermally treated particle material of clause 23, wherein the silica particles have a final pore volume in the range of 0.7 to 1.2 cc/g
26. The thermally treated particle material of clause 23, wherein the silica particles have a final pore volume of about 0.8 cc/g.
27. The thermally treated particle material of clause 23, wherein the silica particles further comprise a surface coating.
28. The thermally treated particle material of clause 23, where in the surface coating is a hydrophilic silane coating.
29. A chromatographic separation device comprising:
   at least one columnar member having an inner void;
   at least one stationary phase packing material within the inner void;
wherein the stationary phase packing material comprises thermally treated particle material, according to the method of claim 1.
30. The chromatographic separation device of clause 29, wherein separation occurs through size exclusion chromatography.
31. The chromatographic separation device of clause 29, wherein the thermally treated particle material comprises silica particles.
32. The chromatographic separation device of clause 29, wherein the silica particles further comprise a surface coating.
33. The chromatographic separation device of clause 29, wherein surface coating is a hydrophilic diol coating.
34. The chromatographic separation device of clause 29, wherein the thermally treated particle material comprises silica particles having a final pore volume of 0.7 to 1.2 cc/g.
35. The chromatographic separation device of clause 29, wherein the thermally treated particle material comprises silica particles having a final pore volume of about 0.8 cc/g.

What is claimed is:

1. A thermal treatment method of a particle material, comprising:
a first heating step, wherein the particle material is heated to a first temperature;
holding the particle material at the first temperature of the first heating step for about 6 hours,
a second heating step, wherein the particle material is heated to a second temperature;
holding the particle material at the second temperature of the second heating step for about 1 hour;
a third heating step, wherein the particle material is heated to a third temperature;
holding the particle material at the temperature of the third heating step for about 6 hours;
wherein the particle material has an initial porosity and a final porosity, and wherein the final porosity is controlled during the third heating step.

2. The thermal treatment method of claim 1, wherein the first temperature is about 120° C. and the second temperature is about 600° C.

3. The thermal treatment method of claim 1, wherein the third temperature is about 1000° C.-1050° C.

4. The thermal treatment method of claim 1, wherein the final porosity is controlled by varying the temperature in the third heating step.

5. The thermal treatment method of claim 1, wherein controlling the final porosity comprises:
a) choosing a desired final porosity, and
b) choosing a specific temperature of the third heating step.

6. The thermal treatment method of claim 1, further comprising:
a. about 30 minutes of total ramp-up time for the first heating step;
b. about 1 hour of total ramp-up time for the second heating step; and
c. about 3 hours of total ramp-up time for the third heating step.

7. The thermal treatment method of claim 1, wherein the temperature of the third heating step is about 1020° C.-1030° C.

8. The thermal treatment of claim 1, wherein the initial porosity comprises an initial pore volume and the final porosity comprises a final pore volume, wherein the final pore volume is lower than the initial pore volume.

9. The thermal treatment of claim 8, wherein the initial pore volume of the particle material is about 1.0-1.8 cc/g.

10. The thermal treatment method of claim 8, wherein the final pore volume of the particle material is about 0.7 to 1.2 cc/g.

11. The thermal treatment method of claim 1, wherein the particle material comprise an average initial pore size of about 225-280 Angstroms.

12. The thermal treatment method of claim 8, wherein the final porosity comprises an average final pore size of about 195-270 Angstroms.

13. The thermal treatment method of claim 1, wherein the particle material comprises silica particles for use in size exclusion chromatography devices.

14. The thermal treatment method of claim 1, wherein the particle material comprises particles with an average particle size of about 1.2 to 3.0 μm.

15. A thermally treated particle material, according to the method of claim 1.

16. The thermally treated particle material of claim 15, wherein the particle material comprises silica particles with a final pore volume in the range of 0.7 to 1.2 cc/g.

17. The thermally treated particle material of claim 15, further comprising a surface coating is a hydrophilic diol coating.

18. A chromatographic separation device comprising:
at least one columnar member having an inner void;
at least one stationary phase packing material within the inner void;
wherein the stationary phase packing material comprises thermally treated particle material, according to the method of claim 1.

19. The chromatographic separation device of claim 18, wherein the thermally treated particle material comprises silica particles having a final pore volume of 0.7 to 1.2 cc/g.

20. The chromatographic separation device of claim 18, wherein the thermally treated particle material comprises silica particles having a final pore size of about 195-270 Angstroms.
